(19) United States
(12) Patent Application Publication
(10) Pub. No.: US 2026/0242664 A1
(43) Pub. Date: Aug. 20, 2026

(54) LIQUID CRYSTAL POLYESTER, FILM, AND METAL-CLAD LAMINATE

(71) Applicant: KANEKA CORPORATION, Osaka (JP)

(72) Inventors: Kosuke Tsuda, Osaka (JP); Yuki Sakai, Osaka (JP)

(73) Assignee: KANEKA CORPORATION, Osaka (JP)

(21) Appl. No.: 19/638,464

(22) Filed: Apr. 3, 2026

Related U.S. Application Data
(63) Continuation of application No. PCT/JP2024/033847, filed on Sep. 24, 2024.

(30) Foreign Application Priority Data
Oct. 3, 2023 (JP) 2023-171879
Jul. 10, 2024 (JP) 2024-111027

(51) Int. Cl. C09K 19/38; B32B 15/09; B32B 27/36; C08G 63/60; C08G 63/685; C08J 5/18

(52) U.S. Cl. CPC C09K 19/3809; B32B 15/09; B32B 27/36; C08G 63/60; C08G 63/6852; C08J 5/18

(57) ABSTRACT

A liquid crystal polyester capable of forming a film that maintains superior low-dielectric properties and has a low linear expansion coefficient and a small difference in linear expansion coefficient between in-plane and thickness directions; a film including the liquid crystal polyester; and a metal-clad laminate including the film are provided. The liquid crystal polyester includes a linear polyester comprising at least one structural unit (A) selected from the group consisting of an aromatic oxycarbonyl unit, an aromatic dioxy unit, and an aromatic dicarboxy unit, and a cross-linking group (B) introduced into a main chain of the structural unit (A) to link the linear polyester. The cross-linking group (B) is derived from a compound comprising an aromatic ring having an electron-donating substituent and at least two methylol groups bonded to the aromatic ring, or a compound having a nitrogen atom and at least two methylol groups bonded to the nitrogen atom.

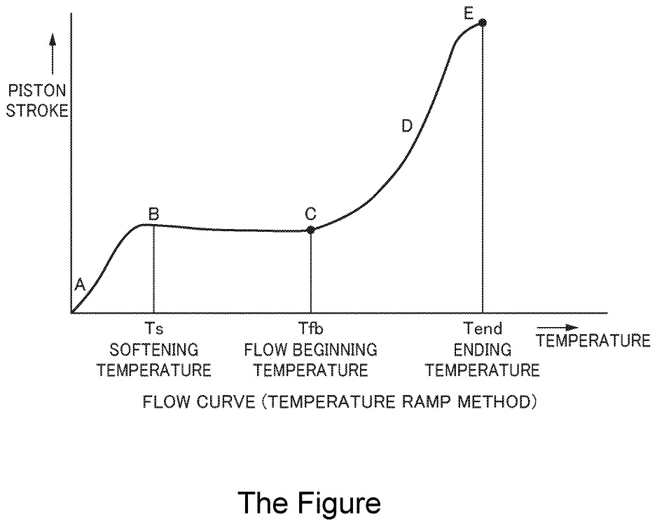

### TECHNICAL FIELD

One or more embodiments of the present invention relate to a liquid crystal polyester, a film including the liquid crystal polyester, and a metal-clad laminate including the film.

### BACKGROUND

Electronic devices required to transmit and receive large volumes of data are increasingly designed to operate at higher signal frequencies. Unfortunately, such an increase in signal frequency will lead to an increase in transmission loss. To reduce such transmission loss, it is necessary to use wiring boards including a base material with low permittivity and low dielectric loss tangent.

In recent years, liquid crystal polyesters, which are excellent in high-frequency characteristics, low permittivity, and low water absorption, have attracted attention as circuit board materials. Potential applications of such materials include flexible printed circuit boards (FPCs) and rigid circuit boards for electronic equipment operating in high-frequency bands, such as smartphone antenna modules and wireless communication base stations for fifth-generation mobile communication system (5G) and automotive millimeter-wave radars.

For example, Patent Document 1 discloses a liquid crystal polymer film for use as a circuit board material, including a blend of a liquid crystal polyester and a thermoplastic resin.

### CITATION LIST

### Patent Documents

Patent Document 1: Japanese Unexamined Patent Application, Publication No. 2004-175995

For use in rigid board applications required to have a multilayer structure, such a material is strongly required to have a low linear expansion coefficient in thickness direction. In this regard, the film disclosed in Patent Document 1 has a successfully reduced linear expansion coefficient of 5 to 25 ppm/K in in-plane direction, but it has a linear expansion coefficient of 270 ppm/K or less in thickness direction, which means that it has a large difference in thermal expansion coefficient between in-plane and thickness directions. In other words, the film disclosed in Patent Document 1 has high material anisotropy. For example, this feature raises concerns about a significant reduction in dimensional accuracy during circuit board processing. In addition, the film disclosed in Patent Document 1 contains a large amount of thermoplastic resin, such as polyarylate, which raises concerns about potential deterioration in heat resistance or dielectric properties.

### SUMMARY

A liquid crystal polyester capable of forming a film that maintains superior low-dielectric properties in high-frequency ranges and has a low linear expansion coefficient in thickness direction and a small difference in linear expansion coefficient between in-plane and thickness directions; a film including such a liquid crystal polyester; and a metal-clad laminate including such a film are provided.

As a result of diligent studies to address the above, the inventors have created a liquid crystal polyester including linear polyester linked by a cross-linking group derived from a specific compound having two or more methylol groups and have found that such a liquid crystal polyester can form a film that maintains superior low-dielectric properties in high-frequency ranges and has a low linear expansion coefficient in thickness direction and a small difference in linear expansion coefficient between in-plane and thickness directions. The inventors have completed one or more embodiments of the present invention based on such findings.

Specifically, one or more embodiments of the present invention are directed to a liquid crystal polyester, a film, and a metal-clad laminate as defined below.
[1] A liquid crystal polyester including: linear polyester including at least one structural unit (A) selected from the group consisting of an aromatic oxycarbonyl unit, an aromatic dioxy unit, and an aromatic dicarboxy unit; and a cross-linking group (B) introduced into the main chain of the structural unit (A) to link the linear polyester, the cross-linking group (B) being derived from a compound including: an aromatic ring having an electron-donating substituent; and at least two methylol groups bonded to the aromatic ring or being derived from a compound having a nitrogen atom and at least two methylol groups bonded to the nitrogen atom, wherein the methylol groups are optionally alkyl-etherified,
the liquid crystal polyester having a cross-linking group (B) content of more than 0 mol % and 4.0 mol % or less based on an amount of the structural unit (A) normalized to 100 mol %.
[2] The liquid crystal polyester according to aspect [1], wherein the cross-linking group (B) has at least one structure selected from the group consisting of an acetylenediurea structure, a triazine structure, and a phenol structure.
[3] The liquid crystal polyester according to aspect [1] or [2], wherein the linear polyester is a wholly aromatic polyester.
[4] The liquid crystal polyester according to any one of aspect [1] to [3], wherein the linear polyester has Type II structure.
[5] The liquid crystal polyester according to any one of aspects [1] to [4], wherein the structural unit (A) contains 20 to 80 mol % of a structure derived from a naphthalene skeleton-containing monomer based on a total amount of the structural unit (A) normalized to 100 mol %.
[6] The liquid crystal polyester according to any one of aspects [1] to [5], wherein the liquid crystal polyester is capable of forming a film having a glass transition temperature (Tg) of 125° C. or more as measured by dynamic mechanical analysis (DMA) and determined from a loss tangent (tan δ) peak top temperature.
[7] The liquid crystal polyester according to any one of aspects [1] to [6], wherein the liquid crystal polyester is capable of forming a film having a linear expansion coefficient α_{Z} (ppm/° C.) in thickness direction, a linear expansion coefficient α_{XY} (ppm/° C.) in in-plane direction of 55 ppm/° C. or less, and an α_{Z}/α_{XY} ratio of 8.0 or less.
[8] The liquid crystal polyester according to aspect [7], wherein the film has a linear expansion coefficient oz in thickness direction of 150 ppm/° C. or less.
[9] A film including the liquid crystal polyester according to any one of aspects [1] to [8].
[10] A metal-clad laminate including: the film according to aspect [9]; and a metal layer provided on at least one main surface of the film.

One or more embodiments of the present invention provide a liquid crystal polyester capable of forming a film that maintains superior low-dielectric properties in high-frequency ranges and has a low linear expansion coefficient in thickness direction and a small difference in linear expansion coefficient between in-plane and thickness directions; a film including such a liquid crystal polyester; and a metal-clad laminate including such a film.

### BRIEF DESCRIPTION OF THE DRAWINGS

The FIGURE is a graph showing an example of a flow curve (rheogram) resulting from the measurement of flow beginning temperature.

### DETAILED DESCRIPTION

### <<Liquid Crystal Polyester>>

An embodiment is directed to a liquid crystal polyester including: linear polyester including a structural unit (A) (described below); and a cross-linking group (B) introduced into the main chain of the structural unit (A) to link the linear polyester. The cross-linking group (B) is derived from a compound including: an aromatic ring having an electron-donating substituent; and at least two methylol groups bonded to the aromatic ring or derived from a compound having a nitrogen atom and at least two methylol groups bonded to the nitrogen atom, in which the methylol groups are optionally alkyl-etherified. The liquid crystal polyester has a cross-linking group (B) content of more than 0 mol % and 4.0 mol % or less based on the amount of the structural unit (A) normalized to 100 mol %. The features (the linear polyester including the structural unit (A) and being linked by the cross-linking group (B) introduced into the main chain of the structural unit (A)) allow the liquid crystal polyester to form a film that maintains superior low-dielectric properties in high-frequency ranges and has a low linear expansion coefficient in thickness direction and a small difference in linear expansion coefficient between in-plane and thickness directions. Hereinafter, the components of the liquid crystal polyester, specifically the linear polyester including the structural unit (A) and the cross-linking group (B) will be described.

### <Linear Polyester Including Structural Unit (A)>

The linear polyester includes the structural unit (A). The linear polyester with such features imparts liquid crystallinity to the liquid crystal polyester. The term “liquid crystallinity” means that the liquid crystal polyester will exhibit an anisotropic melt phase when heated.

### [Structural Unit (A)]

The structural unit (A) is at least one selected from the group consisting of an aromatic oxycarbonyl unit, an aromatic dioxy unit, and an aromatic dicarboxy unit. In particular, the linear polyester may include at least an aromatic oxycarbonyl unit as the structural unit (A).

The structural unit (A) may include an aromatic oxycarbonyl unit represented by Formula (A-1) below, an aromatic dioxy unit represented by Formula (A-2) below, or an aromatic dicarboxy unit represented by Formula (A-3) below.

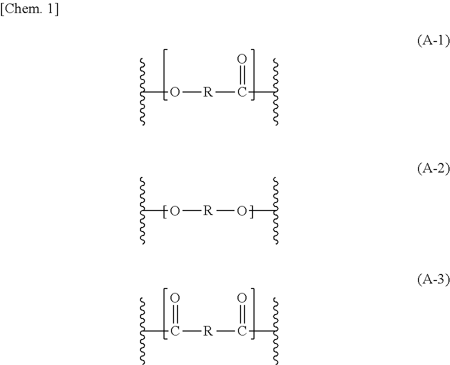

In Formulae (A-1), (A-2), and (A-3), R represents an aromatic skeleton. R is derived from a monomer having an aromatic skeleton. For example, the aromatic skeleton may be a benzene skeleton or a naphthalene skeleton.

The structural unit (A) may contain 20 to 80 mol %, 30 to 80 molo, or 40 to 80 mol % of a structure derived from a naphthalene skeleton-containing monomer based on the amount of all structures constituting the structural unit (A), which is normalized to 100 mol %.

The structural unit (A) may contain 20 to 80 mol %, 20 to 70 mol %, or 20 to 60 mol % of a structure derived from a benzene skeleton-containing monomer based on the amount of all structures constituting the structural unit (A), which is normalized to 100 mol %.

### (Aromatic Oxycarbonyl Unit)

The aromatic oxycarbonyl unit may be derived from an aromatic hydroxycarboxylic acid monomer. Examples of aromatic hydroxycarboxylic acids from which the aromatic oxycarbonyl unit can be derived or introduced include 4-hydroxybenzoic acid, 3-hydroxybenzoic acid, 2-hydroxybenzoic acid, 6-hydroxy-2-naphthoic acid, 6-hydroxy-1-naphthoic acid, 7-hydroxy-2-naphthoic acid, 3-hydroxy-2-naphthoic acid, 7-hydroxy-1-naphthoic acid, 4′-hydroxyphenyl-4-benzoic acid, 3′-hydroxyphenyl-4-benzoic acid, 4′-hydroxyphenyl-3-benzoic acid, and alkyl-, alkoxy-, or halogen-substituted derivatives thereof. In particular, 4-hydroxybenzoic acid, 6-hydroxy-2-naphthoic acid, or a combination thereof is preferred to provide the liquid crystal polyester with easily controllable heat resistance, dielectric properties, and melting point. Ester derivatives of aromatic hydroxycarboxylic acids and ester-forming derivatives of acid halides and similar compounds are also as useful as the aromatic hydroxycarboxylic acids.

### (Aromatic Dioxy Unit)

The aromatic dioxy unit may be derived from an aromatic diol monomer. Examples of aromatic diols from which the aromatic dioxy unit can be derived or introduced include hydroquinone, resorcinol, 2,6-dihydroxynaphthalene, 2,7-dihydroxynaphthalene, 1,4-dihydroxynaphthalene, 1,5-dihydroxynaphthalene, 1,6-dihydroxynaphthalene, 3,3′-dihydroxybiphenyl, 3,4′-dihydroxybiphenyl, 4,4′-dihydroxybiphenyl, 4,4′-dihydroxydiphenyl ether, 2,2′-dihydroxybinaphthyl, and alkyl-, alkoxy-, or halogen-substituted derivatives thereof, as well as ester-forming derivatives thereof, such as acylation products thereof. In particular, hydroquinone, 2,6-dihydroxynaphthalene, or a combination thereof is preferred.

### (Aromatic Dicarboxy Unit)

The aromatic dicarboxy unit may be derived from an aromatic dicarboxylic acid monomer. Examples of aromatic dicarboxylic acids from which the aromatic dicarboxy unit can be derived or introduced include terephthalic acid, isophthalic acid, 1,4-naphthalenedicarboxylic acid, 1,5-naphthalenedicarboxylic acid, 1,6-naphthalenedicarboxylic acid, 2,6-naphthalenedicarboxylic acid, 2,7-naphthalenedicarboxylic acid, 4,4′-dicarboxybiphenyl, 3,4′-dicarboxybiphenyl, 4,4′-dicarboxydiphenyl ether, 4,4′-dicarboxyterphenyl, and alkyl-, alkoxy-, or halogen-substituted derivatives thereof. In particular, terephthalic acid, 2,6-naphthalenedicarboxylic acid, or a combination thereof is preferred.

For heat resistance and flame retardancy, the linear polyester may be a wholly aromatic polyester.

Linear polyesters can be conveniently classified into liquid crystal polyesters having Type I, Type II, and Type III structures in order of decreasing heat resistance. In this regard, melting point is used as an indicator of heat resistance. Liquid crystal polyesters having Type I structure are meant to have a melting point of 340° C. or more. Liquid crystal polyesters having Type II structure are meant to have a melting point of 260° C. or more and less than 330° C. Liquid crystal polyesters having Type III structure are meant to have a melting point of less than 240° C. The linear polyester may have any of Type I, Type II, or Type III structure. In view of heat resistance, dielectric loss tangent, and melt formability, a Type II structure is preferable.

### <Cross-Linking Group (B)>

As mentioned above, the cross-linking group (B) is a group derived from a compound including: an aromatic ring having an electron-donating substituent; and at least two methylol groups bonded to the aromatic ring (hereinafter also referred to as the “cross-linking group (B-I)”) or a group derived from a compound having a nitrogen atom and at least two methylol groups bonded to the nitrogen atom (hereinafter also referred to as the “cross-linking group (B-II)”).

### [Cross-Linking Group (B-I)]

For example, the cross-linking group (B-I) may have, as the aromatic ring, a benzene ring, a fluorene ring, a naphthalene ring, an anthracene ring, a phenanthrene ring, a biphenyl ring, or an aromatic heterocyclic ring having a heteroatom(s) substituted for some of carbon atoms in any one of the foregoing aromatic rings. The heteroatom in the aromatic heterocyclic ring may be oxygen, sulfur, or nitrogen. In particular, the aromatic ring may be a benzene ring.

The cross-linking group (B-I) may have two or more aromatic rings, which may include the same or different aromatic rings linked by a single bond or a divalent linking group. Examples of such aromatic rings include those listed above. In such a mode, the two or more aromatic rings may be two or more benzene rings linked by a divalent linking group. For example, the divalent linking group may be a divalent saturated hydrocarbon group or a divalent oxygen-containing group.

The divalent saturated hydrocarbon group may be linear, branched, or cyclic. The divalent saturated hydrocarbon group may have 1 to 8 carbon atoms, or 1 to 4 carbon atoms. Examples of the divalent saturated hydrocarbon group include-CH₂—, —CH₂CH₂—, —C((CH₃)₂)—, and —CH(C₆H₅)—. In particular, the divalent saturated hydrocarbon group may be —CH₂— or —C((CH₃)₂)—.

For example, the divalent oxygen-containing group may be a non-hydrocarbon oxygen-containing group, such as an ether bond (—O—), an ester bond (—C(═O)—O—), an oxycarbonyl group (—O—C(═O)—), an amide bond (—C(═O)—NH—), a carbonyl group (—C(═O)—), or a carbonate bond (—O—C(═O)—O—); or a combination of a non-hydrocarbon oxygen-containing group and an alkylene group. The divalent oxygen-containing group may also be a group including such a combination and a sulfonyl group (—SO₂—) bonded thereto.

The aromatic ring has an electron-donating substituent. For example, the electron-donating substituent may be a hydroxy group, an alkoxy group having 1 to 8 carbon atoms, an alkylthio group having 1 to 8 carbon atoms, a linear or branched monosubstituted amino group having 1 to 4 carbon atoms, or a linear or branched disubstituted amino group having 1 to 4 carbon atoms. In particular, the electron-donating substituent may be a hydroxy group.

The cross-linking group (B-I) may have 2 or more and 12 or less methylol groups, or 2 or more and 8 or less methylol groups.

For example, the cross-linking group (B-I) may be derived from a compound having a benzene ring with a hydroxy group as an electron-donating substituent and having two or more methylol groups bonded to the benzene ring. Herein, the cross-linking group (B-I) derived from such a compound is also referred to as the “cross-linking group (B-I) having a phenol structure”.

### [Cross-Linking Group (B-II)]

In the cross-linking group (B-II), a nitrogen atom linked to the methylol group may be a nitrogen atom constituting a ring in a compound having a cyclic skeleton, or a nitrogen atom in a nitrogen-containing substituent of a compound having a cyclic skeleton. The cyclic skeleton may be a carbon ring skeleton with only carbon atoms forming the ring or may be a heterocyclic skeleton including a carbon atom(s) and any other atom than carbon. The cyclic skeleton may be an aromatic ring skeleton or an alicyclic skeleton. The cyclic skeleton may be monocyclic or polycyclic.

For example, the compound having the cyclic skeleton may be an aromatic compound, such as benzene, fluorene, naphthalene, anthracene, phenanthrene, or biphenyl; an aromatic heterocyclic compound having a nitrogen atom(s) substituted for some of carbon atoms in the aromatic compound; a monocyclic cycloalkane having 5 to 15 carbon atoms; a polycyclic cycloalkane having two or more monocyclic cycloalkane linked or condensed with each other; or a compound having a monocyclic or polycyclic cycloalkane moiety having a nitrogen atom(s) substituted for some of carbon atoms in the cycloalkane moiety. For example, the compound having the cyclic skeleton may be a triazine ring-containing compound or a compound having an acetylenediurea structure (glycoluril structure).

For example, the nitrogen-containing substituent may be an amino group represented by —NH₂ or a secondary amino group represented by —NHR. R represents a monovalent substituent. For example, the monovalent substituent may be an alkyl group, an aryl group, or an alkoxy group. The cross-linking group (B-II) may have such an amino or secondary amino group with hydrogen atoms replaced by methylol groups, which are bonded to the nitrogen atom.

For example, the cross-linking group (B-II) may be a group derived from a compound having a triazine ring with a nitrogen-containing substituent bonded to a carbon atom in the triazine ring and having at least two methylol groups bonded to the nitrogen atom in the nitrogen-containing substituent (hereinafter, the cross-linking group (B-II) derived from such a compound will also be referred to as the “cross-linking group (B-II) having a triazine structure”); or a group derived from a compound having an acetylenediurea structure and at least two methylol groups bonded to the nitrogen atom in the acetylenediurea structure (hereinafter, the cross-linking group (B-II) derived from such a compound will also be referred to as the “cross-linking group (B-II) having an acetylenediurea structure”).

The methylol groups in the cross-linking group (B) are optionally alkyl-etherified. For example, such an alkyl group may be methyl or ethyl.

The liquid crystal polyester can form a film that maintains superior low-dielectric properties in high-frequency ranges and has a low linear expansion coefficient in thickness direction and a small difference in linear expansion coefficient between in-plane and thickness directions. For such advantageous effects, the content of the cross-linking group (B) in the liquid crystal polyester may have an upper limit of 4.0 mol % or less, 3.5 mol % or less, or 3.0 mol % or less, based on the amount of the structural unit (A) normalized to 100 mol %. The content of the cross-linking group (B) in the liquid crystal polyester may have a lower limit more than 0 mol %, 0.1 mol % or more, or 0.2 mol % or more, based on the amount of the structural unit (A) normalized to 100 mol %.

### <<Method for Producing the Liquid Crystal Polyester>>

The liquid crystal polyester described above is typically produced by polycondensation of a monomer mixture including acylation products of monomers having a phenolic hydroxyl group. The polycondensation for producing the liquid crystal polyester may be performed using any suitable method, such as melt acidolysis or slurry polymerization.

In view of cost and production time, the melt acidolysis is a preferred method for producing the liquid crystal polymer. The melt acidolysis method may include first heating monomers to form a melt; and then allowing the polycondensation reaction of the melt to proceed to form a molten polymer. In the method, the final stage of the condensation may be performed under vacuum so that the resulting volatile by-products (e.g., acetic acid, water) can be easily removed.

The slurry polymerization is a method of reacting monomers in the presence of a heat exchange fluid, which produces a solid product suspended in the heat exchange medium.

The acylation products of monomers having a phenolic hydroxyl group may be synthesized using an acylating agent, such as acetic anhydride or acetic acid, added to the reaction system for the synthesis of the liquid crystal polyester and then used for the synthesis of the liquid crystal polyester. Alternatively, the acylation products of monomers having a phenolic hydroxyl group may be separately synthesized by acylation and then used for the synthesis of the liquid crystal polyester.

In the case where the acylation of monomers having a phenolic hydroxyl group is performed in the reaction system, the acylating agent may be used in an amount 1.1 times or more the total amount of phenolic hydroxyl groups in the monomers.

The polymerization reaction may be performed at a temperature of 200 to 400° C., or at a temperature of 250 to 350° C. under a normal pressure and/or a reduced pressure.

The polycondensation may be performed in the presence of a catalyst. Examples of the catalyst include metal compounds, such as magnesium acetate, tin (II) acetate, tetrabutyl titanate, lead acetate, sodium acetate, potassium acetate, and antimony trioxide; and nitrogen-containing heterocyclic compounds, such as 1-methylimidazole.

The catalyst may be used in any suitable amount. For example, the catalyst may be used in an amount of 0.1 parts by mass or less based on 100 parts by mass of the monomer mixture. The polycondensation reaction described above produces the liquid crystal polyester in the form of a melt. In general, the melt of the liquid crystal polyester is removed from the reaction vessel and then processed into a powder, pellets, or flakes.

The liquid crystal polyester pellets may be produced through melting and kneading the liquid crystal polyester powder to form strands. The melting and kneading may be performed at any suitable temperature. For stable formation of strands, the melting and kneading may be performed at a temperature in the range of (the flow beginning temperature of the liquid crystal polyester powder) −10° C. to (the flow beginning temperature of the liquid crystal polyester powder)+30° C., or in the range of (the flow beginning temperature of the liquid crystal polyester powder) −5° C. to (the flow beginning temperature of the liquid crystal polyester powder)+20° C.

The pellets, flakes or powder of the liquid crystal polyester may be heated under reduced pressure, vacuum, or an inert gas atmosphere such as nitrogen or helium to undergo a solid-phase polymerization reaction for increasing the molecular weight. When heated in solid phase, the liquid crystal polyester is expected to have improved heat resistance and other properties.

The liquid crystal polyester resulting from the method described above may be evaluated for liquid crystallinity by a conventional polarization test using crossed polarizers to confirm whether it exhibits optical anisotropy when melted.

### (Other Additive)

The liquid crystal polyester described above may be mixed as needed with an inorganic filler to form a liquid crystal polyester composition for applications. Examples of the inorganic filler include calcium carbonate, talc, clay, silica, magnesium carbonate, barium sulfate, titanium oxide, alumina, montmorillonite, gypsum, glass flakes, glass fibers, milled glass fibers, carbon fibers, alumina fibers, silica-alumina fibers, aluminum borate whiskers, and potassium titanate fibers. One of the inorganic fillers may be used alone, or two or more of the inorganic fillers may be used in combination.

The inorganic filler may be used in any suitable amount that is selected as appropriate depending on the intended use of the liquid crystal polyester within a range where the low dielectric properties of the liquid crystal polyester are not impaired. For example, the content of the inorganic filler in the liquid crystal polyester composition for forming a film should have an upper limit selected within a range where it will not significantly impair the mechanical strength of the film.

If necessary, the liquid crystal polyester composition may further contain various additives, such as an organic filler, an antioxidant, a heat stabilizer, a light stabilizer, a flame retardant, a lubricant, an antistatic agent, a colorant, a rust inhibitor, a cross-linking agent, a foaming agent, a fluorescent agent, a surface smoothing agent, a surface gloss improver, and a mold release agent. One of these additives may be used alone, or two or more of these additives may be used in combination.

### <<Applications>>

The liquid crystal polyester or the liquid crystal polyester composition (hereinafter also simply referred to as the “liquid crystal polyester, etc.”) may be heated at a temperature higher than or equal to its melting point and subjected to a known shaping method, such as press molding, extrusion molding, injection molding, compression molding, or blow molding to form shaped products, films, or fibers.

Among the applications, for example, pellets of the liquid crystal polyester, etc. may be formed into a film. In such a case, although the film may be formed at any suitable temperature, the pellets may be heated at a temperature in the range of (the flow beginning temperature of a powder of the liquid crystal polyester, etc.) to (the flow beginning temperature of the powder of the liquid crystal polyester, etc.)+30° C., or in the range of (the flow beginning temperature of a powder of the liquid crystal polyester, etc.) +5° C. to (the flow beginning temperature of the powder of the liquid crystal polyester, etc.)+20° C., in order to form a film that maintains superior low-dielectric properties in high-frequency ranges and has a small difference in linear expansion coefficient between in-plane and thickness directions. The method for measuring the flow beginning temperature is explained in the examples described later.

### <Properties of the Film>

### (Glass Transition Temperature)

The film resulting from the shaping of the liquid crystal polyester, etc. may have a glass transition temperature (Tg) of 125° C. or more, or 140° C. or more. The melting point of the film can be determined by reading the loss tangent (tan δ) peak top temperature measured by dynamic mechanical analysis (DMA).

### (Dielectric Constant)

The film resulting from the shaping of the liquid crystal polyester, etc. may have a dielectric constant of 8.0 or less, 6.0 or less, 5.0 or less, or 4.0 or less, at a frequency of 28 GHz. The dielectric constant of the resin film can be measured by the method described in the Examples section below.

### (Dielectric Loss Tangent)

The film resulting from the shaping of the liquid crystal polyester, etc. may have a dielectric loss tangent of 0.0030 or less, 0.0028 or less, 0.0027 or less, or 0.0025 or less, at a frequency of 28 GHz. The dielectric loss tangent of the resin film can be measured by the method described in the Examples section below.

### (Linear Expansion Coefficient)

As a non-limiting example, the film resulting from the shaping of the liquid crystal polyester, etc. may have a linear expansion coefficient in in-plane direction (hereinafter also referred to as “XY-CTE” or “α_{XY}”) of 55 ppm/C or less, 50 ppm/° C. or less, or 45 ppm/° C. or less. As a non-limiting example, the film may have a linear expansion coefficient in thickness direction (hereinafter also referred to as “Z-CTE” or “+_{Z}”) of 150 ppm/° C. or less, 120 ppm/° C. or less, 100 ppm/° C. or less, or 90 ppm/° C. or less. The XY-CTE and Z-CTE can be evaluated by the method described in the Examples section below.

### (Linear Expansion Anisotropy)

The degree of linear expansion anisotropy of the film resulting from the shaping of the liquid crystal polyester, etc. may be evaluated using, as an indicator, the ratio (α_{Z}/α_{XY}) of the linear expansion coefficient +_{Z} (ppm/° C.) in thickness direction to the linear expansion coefficient α_{XY} (ppm/° C.) in in-plane direction of the film. The ratio α_{Z}/α_{XY} may be 8.0 or less, 7.0 or less, or 6.0 or less. The degree of linear expansion anisotropy can be evaluated by the method described in the Examples section below.

The film resulting from the shaping of the liquid crystal polyester, etc. maintains superior low-dielectric properties in high-frequency ranges and has a low linear expansion coefficient in thickness direction and a small difference in linear expansion coefficient between in-plane and thickness directions. The film with such features is suitable for use as a component of a metal-clad laminate. Such a metal-clad laminate may include the film described above and a metal layer provided on at least one main surface of the film.

### EXAMPLES

Hereinafter, one or more embodiments of the present invention will be described in more detail with reference to examples. It will be understood that the examples are not intended to limit the present invention.

### Examples 1 to 11 and Comparative Examples 1 to 6

### Materials Used

The examples and comparative examples were performed using the monomers A1 and A2 below (collectively referred to as monomers A) for the structural unit (A). A1: 4-Hydroxybenzoic acid
A2: 6-Hydroxy-2-naphthoic acid

The examples and comparative examples were performed using the compound B1, B2, B3, B4, B5, B6, or B7 below (collectively referred to as the compound B) for the cross-linking group (B). Among them, the compound B1, B2, B3, B4, or B5 is for the cross-linking group (B) according to one or more embodiments of the present invention. B6 or B7 is a comparative compound.
B1: Tetramethylol acetylenediurea
B2: Tetramethoxymethyl acetylenediurea
B3: Hexamethoxymethylmelamine
B4: 2,6-Dihydroxymethyl-4-methylphenol
B5: 2,2′-Bis(4-hydroxy-3,5-dihydroxymethylphenyl) propane
B6: 4,4′-Bis(methoxymethyl)benzene
B7: Tetramethylolmethane (pentaerythritol)

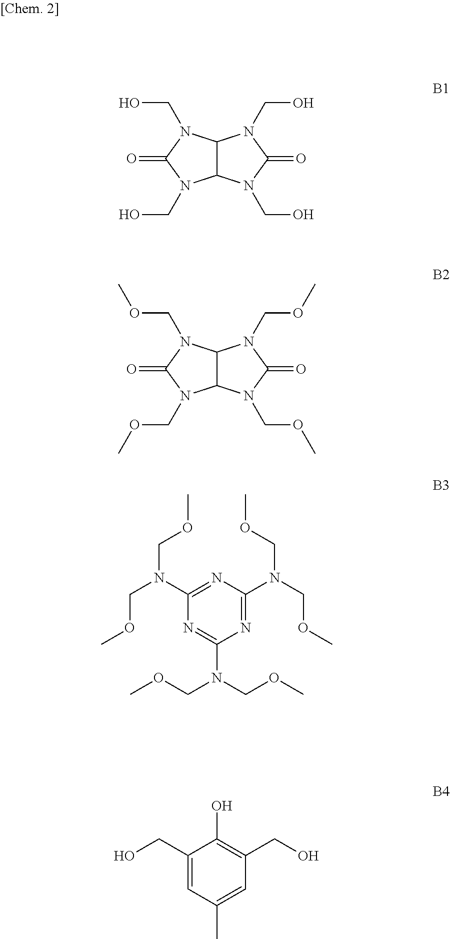

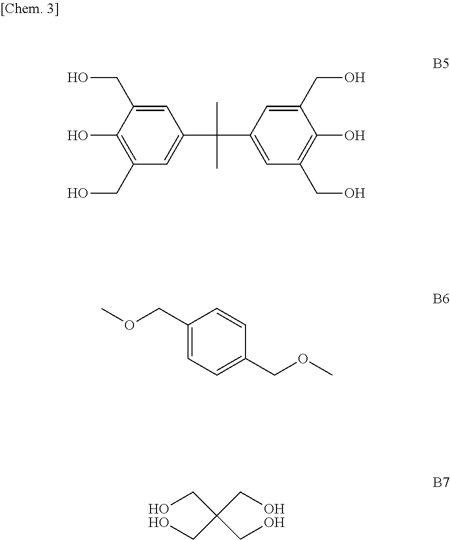

### Example 1

The amounts of the compounds A1, A2, and B1 shown below were added to a reaction vessel equipped with a torque meter-equipped stirring machine, a distillation head, and a reflux condenser. To the reaction vessel were further added acetic anhydride in a molar amount 1.1 times the amount (moles) of hydroxy groups in all the compounds added and a catalytic amount of 1-methylimidazole. The mixture was subjected to polycondensation with elimination of acetic acid under the conditions described below. A1: 27.6 g (50.0 mol %)
A2: 37.6 g (50.0 mol %)
B1: 0.524 g (0.5 mol %)

After the reaction vessel was thoroughly purged with nitrogen gas, the mixture was heated to 145° C. under stirring and held at 145° C. for 30 minutes. The temperature was then rapidly raised to 185° C. and held at 185° C. for 30 minutes. Subsequently, the mixture was heated to 260° C. over 20 minutes and then held at 260° C. for 2 hours and 30 minutes while acetic acid (by-product) was removed by distillation. Subsequently, the pressure in the reaction vessel was reduced to 7.5 torr over 10 minutes and then held at 7.5 torr for 1 hour. Subsequently, the temperature was rapidly raised to 265° C. and held at 265° C. for 30 minutes while the degree of vacuum was maintained. The temperature was then rapidly raised to 270° C. and held at 270° C. for 30 minutes while the degree of vacuum was maintained. Subsequently, the temperature was rapidly raised to 275° C. while the degree of vacuum was maintained. At the time when the indicated torque reached a predetermined value, the reaction was deemed to reach completion, and the contents were removed from the reaction vessel. The resulting solid product was allowed to cool to room temperature and then ground in a mill. The ground product was washed with methanol and then dried. Subsequently, the product was held at 300° C. for 2 hours under a nitrogen atmosphere to undergo solid-phase polymerization reaction. The resulting solid product was then ground again in a mill to give a liquid crystal polyester powder of Example 1.

### Examples 2 to 11 and Comparative Examples 1 to 6

A liquid crystal polyester powder of each of Examples 2 to 11 and Comparative Examples 1 to 6 was produced as in Example 1, except that the monomers for the structural unit (A) and the compound for the cross-linking group (B) were used in the proportion shown in Table 1 or 2 (in which each proportion value is indicted in units of mol %).

### [Flow Beginning Temperature]

The flow beginning temperature of the liquid crystal polyester powder obtained in each of the examples and comparative examples was measured by the method described below. A Koka-type flow tester CFT 500D manufactured by Shimadzu Corporatino was used to measure the flow beginning temperature. Two grams of the liquid crystal polyester powder was loaded into the tester and heated at a rate of 5.0° C./min when extruded through a die with an aperture diameter of 1.0 mm and a length of 10 mm under a load of 10 MPa. The resulting flow curve data is shown in the FIGURE. The flow beginning temperature (Tfb) was determined as the temperature at which the resin extruding piston began to descend. The results are shown in Tables 1 and 2.

### [Resin Film Preparation]

Liquid crystal polyester resin films were prepared using Mini Test Press MP-2F (manufactured by Toyo Seiki-Seisaku-Sho Ltd.). Specifically, the liquid crystal polyester powder of each of the examples and comparative examples was placed into a 0.31 mm-thick brass spacer, which was then sandwiched between two stainless steel plates and heated and pressed under a pressure of 10 MPa at a temperature of 360° C. for 3 minutes to form a resin film. The thickness of the resulting film was measured using a micrometer. The appearance of the resulting film was visually inspected for the presence of air bubbles.

### [Evaluation of Resin Films]

Each of the resulting films was measured for dielectric loss tangent, linear expansion coefficient in in-plane direction, linear expansion coefficient in thickness direction, linear expansion anisotropy, and glass transition temperature using the methods described below. The results are shown in Tables 1 and 2.

### <Dielectric Constant (Dk) and Dielectric Loss Tangent (Df)>

The dielectric loss tangent of each film was measured using a network analyzer (N5222B manufactured by Keysight Technologies) and a split-cylinder resonator (CR-728 manufactured by EM labs). A sample measuring 3.5 cm ×5.0 cm was cut from each film. After being conditioned in the environment at 23° C. and 50% R.H. for 24 hours, the sample was measured for dielectric constant (Dk) and dielectric loss tangent (Df). The measurement was conducted at 28 GHZ.

### <Linear Expansion Coefficient in In-Plane Direction (XY-CTE)>

The linear expansion coefficient in in-plane direction of each film was measured by a tensile test using a thermomechanical analyzer (TMA4000SA manufactured by NESZSCH). A sample measuring 5 mm×10 mm was cut from each film. While a chart was prepared, the sample was heated at a rate of 10° C./min to 80 to 150° C. under a nitrogen gas stream, then cooled at a rate of 20° C./min to 30° C., and heated again at a rate of 10° C./min. The linear expansion coefficient in in-plane direction of the sample (α_{XY} or XY-CTE) was calculated using Equation (1) below, in which L₁ is the length of the sample at 25° C. (T₁) in the resulting chart, L₂ is the length of the sample at its glass transition temperature (T₂) (the value measured using a differential scanning calorimeter), and L₀ is a reference length.

$${α}_{XY} = \frac{1}{{L}_{0}} . \frac{{L}_{2} - {L}_{1}}{{T}_{2} - {T}_{1}} \qquad \text{?} ( 1 )$$

### <Linear Expansion Coefficient in Thickness Direction (Z-CTE)>

The linear expansion coefficient in thickness direction of each film was measured by compressive load method using a thermomechanical analyzer (TMA8310 manufactured by Rigaku). A sample measuring 5 mm×5 mm×1 mm (thickness) was cut from each film. While a chart was prepared, the sample was heated at a rate of 10° C./min to 80 to 150° C. under a nitrogen gas stream, then cooled at a rate of 8° C./min to 25° C., and heated again at a rate of 10° C./min. The linear expansion coefficient in thickness direction of the sample (dz or Z-CTE) was calculated using Equation (2) below, in which L₁ is the length of the sample at 25° C. (T₁) in the resulting chart, L₂ is the length of the sample at its glass transition temperature (T₂) (the value measured using a differential scanning calorimeter), and L₀ is a reference length.

$${α}_{z} = \frac{1}{{L}_{0}} . \frac{{L}_{2} - {L}_{1}}{{T}_{2} - {T}_{1}} \qquad \text{?} ( 2 )$$

### <Linear Expansion Anisotropy>

The degree of linear expansion anisotropy of each sample was expressed by the ratio (α_{Z}/α_{XY}) of the linear expansion coefficient in thickness direction (α_{Z}) to that in in-plane direction (α_{XY}) of each sample. The closer the ratio is to 1, the smaller the degree of linear expansion anisotropy is.

### <Glass Transition Temperature (tan δ (Tg))>

The glass transition temperature of the film was measured using a dynamic viscoelasticity measuring device (DMS8100 manufactured by TA Instruments). The glass transition temperature was determined as the tan δ peak top temperature (tan δ (Tg)).
Sample measurement range: 5 mm width.
Measurement temperature range: 25° C. to 300° C.
Heating rate: 5° C./min
Strain amplitude: 10 μm.
Measurement frequency: 10 Hz

TABLE 1

| | | Example | Example | Example | Example | Example | Example |
|---|---|---|---|---|---|---|---|
| | | 1 | 2 | 3 | 4 | 5 | 6 |
| Monomer A | A1 | 50.0 | 50.0 | 50.0 | 50.0 | 50.0 | 25.0 |
| | A2 | 50.0 | 50.0 | 50.0 | 50.0 | 50.0 | 75.0 |
| Compound B | B1 | 0.5 | 1.0 | 1.5 | 2.0 | — | 0.5 |
| (Acetylenediurea | B2 | — | — | — | — | 1.0 | — |
| structure) | | | | | | | |
| Compound B | B3 | — | — | — | — | — | — |
| (Triazine | | | | | | | |
| structure) | | | | | | | |
| Compound B | B4 | — | — | — | — | — | — |
| (Phenol | B5 | — | — | — | — | — | — |
| structure) | | | | | | | |
| Compound B | B6 | — | — | — | — | — | — |
| | B7 | — | — | — | — | — | — |
| Evaluation | Flow | 280 | 334 | 358 | 392 | 335 | 332 |
| items | beginning | | | | | | |
| | temperature | | | | | | |
| | (° C.) | | | | | | |
| | tanδ (Tg)/° C. | 145 | 157 | 167 | 179 | 160 | 145 |
| | Dielectric | 3.3 | 3.3 | 3.2 | 3.2 | 3.4 | 3.4 |
| | constant | | | | | | |
| | (Dk) | | | | | | |
| | Dielectric | 0.0015 | 0.0015 | 0.0017 | 0.0019 | 0.0016 | 0.0012 |
| | loss tangent | | | | | | |
| | (Df) | | | | | | |
| | XY-CTE | 20 | 40 | 40 | 43 | 19 | 44 |
| | ppm/° C. | | | | | | |
| | Z-CTE | 63 | 70 | 91 | 105 | 98 | 90 |
| | ppm/° C. | | | | | | |
| | α_{Z}/α_{XY} | 3.15 | 1.75 | 2.28 | 2.44 | 5.16 | 2.05 |

| | | Example | Example | Example | Example | Example |
|---|---|---|---|---|---|---|
| | | 7 | 8 | 9 | 10 | 11 |
| Monomer A | A1 | 25.0 | 50.0 | 50.0 | 50.0 | 50.0 |
| | A2 | 75.0 | 50.0 | 50.0 | 50.0 | 50.0 |
| Compound B | B1 | 1.0 | — | — | — | — |
| (Acetylenediurea | B2 | — | — | — | — | — |
| structure) | | | | | | |
| Compound B | B3 | — | 0.5 | 1.0 | — | — |
| (Triazine | | | | | | |
| structure) | | | | | | |
| Compound B | B4 | — | — | — | 1.0 | — |
| (Phenol | B5 | — | — | — | — | 1.0 |
| structure) | | | | | | |
| Compound B | B6 | — | — | — | — | — |
| | B7 | — | — | — | — | — |
| Evaluation | Flow | 390 | 320 | >400 | 372 | >400 |
| items | beginning | | | | | |
| | temperature | | | | | |
| | (° C.) | | | | | |
| | tanδ (Tg)/° C. | 165 | 158 | 181 | 146 | 177 |
| | Dielectric | 3.4 | 3.4 | 3.2 | 3.4 | 3.3 |
| | constant | | | | | |
| | (Dk) | | | | | |
| | Dielectric | 0.0011 | 0.0015 | 0.0016 | 0.0019 | 0.0020 |
| | loss tangent | | | | | |
| | (Df) | | | | | |
| | XY-CTE | 17 | 22 | 20 | 28 | 23 |
| | ppm/° C. | | | | | |
| | Z-CTE | 112 | 95 | 101 | 145 | 75 |
| | ppm/° C. | | | | | |
| | α_{Z}/α_{XY} | 6.59 | 4.32 | 5.05 | 5.18 | 3.26 |

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Monomer A | A1 | 50.0 | 25.0 | 50.0 | 50.0 | 25.0 | 50.0 |
| | A2 | 50.0 | 75.0 | 50.0 | 50.0 | 75.0 | 50.0 |
| Compound B | B1 | — | — | — | — | — | 5.0 |
| (Acetylenediurea | B2 | — | — | — | — | — | — |
| structure) | | | | | | | |
| Compound B | B3 | — | — | — | — | — | — |
| (Triazine | | | | | | | |
| structure) | | | | | | | |
| Compound B | B4 | — | — | — | — | — | — |
| (Phenol | B5 | — | — | — | — | — | — |
| structure) | | | | | | | |
| Compound B | B6 | — | — | 2.0 | — | — | — |
| | B7 | — | — | — | 5.0 | 5.0 | — |
| Evaluation | Flow | 252 | 340 | 240 | 255 | 340 | >400 |
| items | beginning | | | | | | |
| | temperature | | | | | | |
| | (° C.) | | | | | | |
| | tanδ (Tg)/° C. | 118 | 120 | 117 | 117 | 121 | Brittle |
| | Dielectric | 3.2 | 3.3 | 3.2 | 3.4 | 3.3 | molded |
| | constant | | | | | | product |
| | (Dk) | | | | | | |
| | Dielectric | 0.0015 | 0.0013 | 0.0018 | 0.0017 | 0.0014 | |
| | loss tangent | | | | | | |
| | (Df) | | | | | | |
| | XY-CTE | 19 | 63 | 60 | 81 | 74 | |
| | ppm/° C. | | | | | | |
| | Z-CTE | 160 | 159 | 125 | 123 | 113 | |
| | ppm/° C. | | | | | | |
| | α_{Z}/α_{XY} | 8.42 | 2.52 | 2.08 | 1.52 | 1.53 | |

The results in Tables 1 and 2 show that the resin films of Examples 1 to 11 maintain superior low-dielectric properties in high-frequency ranges and have a low linear expansion coefficient in thickness direction and a small difference in linear expansion coefficient between in-plane and thickness directions as compared to the resin films of Comparative Examples 1 to 6.

### Example 12

### [Preparation of Liquid Crystal Polyester Resin Pellets]

The liquid crystal polyester powder (100 parts by mass) of Example 1 was fed through the hopper inlet into a twin-screw extruder (HK-25D (41D) manufactured by Parker Corporation, 25 mm in diameter, L/D=41) with the cylinder temperature and the screw rotation speed set to 285° C. and 200 rpm, respectively, and melted and kneaded to form liquid crystal polyester resin pellets.

### [Flow Beginning Temperature]

The flow beginning temperature of the liquid crystal polyester resin pellets of Example 12 was measured using the same method as described above, except that 1.6 g of the liquid crystal polyester resin pellets were loaded instead of 2 g of the liquid crystal polyester powder of Example 1. The results are shown in Table 3.

### [Preparation of Resin Film]

A resin film was prepared using the same method as described above, except that the liquid crystal polyester resin pellets of Example 12 were heated and pressed under a pressure of 10 MPa at a temperature of 290° C. for 3 minutes instead of the heating and pressing of the liquid crystal polyester powder of Example 1 under a pressure of 10 MPa at a temperature of 360° C. for 3 minutes.

### [Evaluation of Resin Film]

Using the same method as described above, the resulting resin film was measured for dielectric constant, dielectric loss tangent, linear expansion coefficient in in-plane direction, linear expansion coefficient in thickness direction, linear expansion anisotropy, and glass transition temperature. The results are shown in Table 3.

For easier comparison, Table 3 shows, in parallel, the results of measurement for the liquid crystal polyester resin pellets of Example 12 and those for the liquid crystal polyester powder of Example 1. Table 3 shows that the melting and processing of the pellets of Example 12 at 285° C. (higher than the flow beginning temperature 280° C. of the liquid crystal polyester powder of Example 1) enabled stable formation of a strand. Table 3 also shows that the resin film was successfully prepared from the liquid crystal polyester resin pellets of Example 12 using a press temperature of 290° C., which was lower than 360° C. in Example 1. In addition, the results on dielectric loss tangent (Df) and α_{Z}/α_{XY} show that the resin film prepared from the liquid crystal polyester resin pellets of Example 12 maintains superior low-dielectric properties in high-frequency ranges and has a smaller difference in linear expansion coefficient between in-plane and thickness directions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A liquid crystal polyester comprising: a linear polyester comprising at least one structural unit (A) selected from the group consisting of an aromatic oxycarbonyl unit, an aromatic dioxy unit, and an aromatic dicarboxy unit; and a cross-linking group (B) introduced into a main chain of the structural unit (A) to link the linear polyester, wherein the cross-linking group (B) is derived from
a compound comprising an aromatic ring having an electron-donating substituent and at least two methylol groups bonded to the aromatic ring, or
a compound comprising a nitrogen atom and at least two methylol groups bonded to the nitrogen atom, and
the liquid crystal polyester has a cross-linking group (B) content of more than 0 mol % and 4.0 mol % or less based on an amount of the structural unit (A) normalized to 100 mol %.

2. The liquid crystal polyester according to claim 1, wherein the methylol groups are alkyl-etherified.

3. The liquid crystal polyester according to claim 1, wherein the cross-linking group (B) comprises at least one structure selected from the group consisting of an acetylenediurea structure, a triazine structure, and a phenol structure.

4. The liquid crystal polyester according to claim 1, wherein the linear polyester is a wholly aromatic polyester.

5. The liquid crystal polyester according to claim 1, wherein the linear polyester has a Type II structure having a melting point of 260° C. or more and less than 330° C.

6. The liquid crystal polyester according to claim 1, wherein the structural unit (A) comprises 20 to 80 mol % of a structure derived from a naphthalene skeleton-containing monomer based on a total amount of the structural unit (A) normalized to 100 mol %.

7. The liquid crystal polyester according to claim 1, wherein a film formed from the liquid crystal polyester has a glass transition temperature (Tg) of 125° C. or more as measured by dynamic mechanical analysis (DMA) and determined from a loss tangent (tan δ) peak top temperature.

8. The liquid crystal polyester according to claim 1, wherein a film formed from the liquid crystal polyester has a linear expansion coefficient α_{Z} (ppm/° C.) in a thickness direction and a linear expansion coefficient α_{XY} (ppm/° C.) in an in-plane direction, wherein α_{XY} is 55 ppm/° C. or less and an α_{Z}/α_{XY} ratio is 8.0 or less.

9. The liquid crystal polyester according to claim 8, wherein the linear expansion coefficient α_{Z} in the thickness direction is 150 ppm/° C. or less.

10. A film comprising the liquid crystal polyester according to claim 1.

11. A metal-clad laminate comprising:
the film according to claim 10; and
a metal layer provided on at least one main surface of the film.
